(19) United States
(12) Patent Application Publication
(10) Pub. No.: US 2026/0330044 A1
(43) Pub. Date: Oct. 22, 2026

(54) STATELESS AUTHENTICATION LEVERAGING STATEFUL CONTEXT

(71) Applicant: Stephen Passen, Marlborough, CT (US)

(72) Inventor: Stephen Passen, Marlborough, CT (US)

(21) Appl. No.: 19/629,792

(22) Filed: Mar. 26, 2026

Related U.S. Application Data
(60) Provisional application No. 63/790,381, filed on Apr. 17, 2025.
(60) Provisional application No. 63/830,796, filed on Jun. 26, 2025.

(51) Int. Cl. G06F 21/62; H04L 9/08; H04L 9/32

(52) U.S. Cl. CPC G06F 21/6209; H04L 9/085; H04L 9/0863; H04L 9/3213; H04L 9/3242

(57) ABSTRACT

Systems and methods are provided for stateless authentication and Zero Trust enforcement using ephemeral hash-based message authentication code (HMAC) tokens and side-channel authorization. A client derives an ephemeral key from a shared secret using a deterministic entropy generator, such as, but not limited to, a time-based generator in some embodiments, and computes an HMAC token over identifiers and context. A client-side listening agent, such as, but not limited to, a browser extension cooperating with a native messaging host in one embodiment, generates an authorization beacon including the token and transmits the beacon to a policy enforcement point (PEP). Upon receiving a protected request, connection, or transport session associated with a protected destination, the PEP correlates the request, connection, or session to the beacon using one or more correlation anchors and permits or denies access based on beacon validation. In some embodiments, a broker aggregates device, identity, or policy factors, computes hashed factor state, and enables distributed token validation bound to posture. The techniques enable scalable, continuous Zero Trust enforcement and reduce reliance on long-lived bearer credentials.

### RELATED APPLICATIONS

This application claims the benefit of U.S. Provisional Patent Application Nos. 63/790,381 and 63/830,796, filed Apr. 17, 2025 and Jun. 26, 2025, respectively, each of which is incorporated herein by reference, in its entirety, for all purposes.

### FIELD OF THE INVENTION

The present disclosure relates to computer security, and more particularly to techniques for authenticating and authorizing communications using ephemeral, hash-based message authentication code (HMAC) tokens and enforcing Zero Trust access control for protected communications, including encrypted transport sessions and other network or application communications, without requiring transmission of the underlying shared secret.

### BACKGROUND OF THE INVENTION

Traditional perimeter security models, such as network firewalls and virtual private networks (VPNs), often operate on an implicit trust assumption: once a client is authenticated or admitted past a boundary, the client may be granted broad or effectively unlimited access to internal resources. In modern enterprise and cloud environments, where applications, identities, and devices are distributed across networks and service providers, this “trust proven once” approach can expand blast radius when credentials or endpoints are compromised, enable lateral movement, and reduce visibility into whether ongoing access remains appropriate. Moreover, routing access through perimeter chokepoints can complicate deployments and constrain scalability, whereas modern architectures often benefit from exposing applications to the Internet (or otherwise making them directly reachable) while enforcing fine-grained access controls at or near the application. As a result, many modern applications rely on session cookies, bearer tokens, JavaScript Object Notation (JSON) Web Tokens (JWTs), or other long-lived credentials to authenticate clients and authorize access to resources. These mechanisms typically require server-side session state, centralized token issuance, or infrastructure that becomes a single point of compromise or a scalability bottleneck. Furthermore, compromised bearer credentials may be replayed and long-lived secrets may enable persistent impersonation.

In addition, bearer-style artifacts such as session cookies, bearer tokens, and similar credentials may be vulnerable to replay when possession of the artifact alone is sufficient for access. Accordingly, there is a need for techniques that can cryptographically bind such artifacts, or other request context, to a proof generated from shared secret material, thereby strengthening authorization without requiring transmission of the secret itself.

Furthermore, unlike single-packet authorization (SPA) approaches that effectively operate as time-based unlock mechanisms at the network layer, there is a need for techniques that can support validation at a finer granularity, including per-request or application-level validation. Ideally, authorization need not be treated as a one-time network admission decision for a time window, but may instead be cryptographically bound to individual requests, sessions, connections, or other application-relevant context.

Zero Trust Network Access (ZTNA) systems seek to address these shortcomings by continuously evaluating user and device trust and enforcing least-privilege access, adhering to the basic principle of never trust, always verify. However, many ZTNA implementations rely on centralized brokers, Transport Layer Security (TLS) termination, or man-in-the-middle (MITM) proxying to inspect traffic and apply policy. Such approaches can introduce latency, require significant processing power as requests increase, can raise privacy concerns where they implement decryption of application payloads, and may be incompatible with certificate pinning, which can result in compatibility issues, particularly when interacting with SaaS applications or devices that enforce strict certificate pinning.

Accordingly, there is a need for lightweight, scalable techniques that (i) provide stateless, ephemeral authentication and authorization suitable for web, APIs, IoT, and distributed systems that ensure compatibility with existing applications and devices, and (ii) enforce Zero Trust access decisions for TLS-protected communications without decrypting, modifying, or terminating the TLS session.

### SUMMARY OF THE INVENTION

The present disclosure provides systems and methods for generating and validating stateless, ephemeral authentication tokens using HMAC and for enforcing Zero Trust policy. In some embodiments, authorization is performed using an out-of-band control channel that preserves end-to-end TLS encryption of application payloads. As used herein, “side-channel” refers to one or more out-of-band authorization messages transmitted separately from the TLS-protected data channel and used by an enforcement point to permit or deny establishment of a TLS tunnel. Although many embodiments are described in connection with transport layer security (TLS)-protected sessions and tunnel establishment, the disclosed techniques are not limited to TLS and may be applied to other encrypted or unencrypted communications in which authentication and/or authorization is desired without transmitting the shared secret used to derive the ephemeral token.

In some embodiments, the techniques provide stateless authentication and/or authorization that can nevertheless leverage stateful context, such as, but not limited to, factor state, policy state, device posture, replay-protection data, or short-lived validation state, without requiring issuance of a conventional long-lived bearer session.

In some embodiments, a client derives an ephemeral key from a shared secret using a time-based one-time password (TOTP) generator or other rotating entropy source. The client computes an HMAC token over one or more identifiers and context values and transmits it to a verifier by inserting the token into a request using a standard mechanism, such as, but not limited to, a custom header, e.g. X-Auth-Token for HTTP. The verifier then independently recomputes an expected token for the client, e.g. by looking up the corresponding seed for that client, applying the same rotation function thereto and validating the token without maintaining per-client session state.

In embodiments, replay protection is enhanced by validating multiple adjacent TOTP steps or using nonce chaining.

In some embodiments, the identifiers and context values used to generate or validate the token may include one or more request-bound or session-bound values, such as, but not limited to, a destination identifier, timestamp, nonce, client identifier, connection identifier, bearer token, session cookie, UUID, intent indicator, or combinations thereof. In this manner, the token may serve as a proof-of-possession artifact bound to such value(s), rather than a standalone bearer artifact.

In some embodiments, a client-side listening agent detects or receives information associated with outbound requests to protected destinations, such as, but not limited to, protected Software as a Service (SaaS) domains, and generates or causes generation of a short-lived authorization beacon for transmission to a policy enforcement point (PEP), which may be implemented as a proxy, gateway, service module, sidecar, application plug-in, SDK, reverse proxy, forward proxy, or other enforcement component. The client-side listening agent may comprise, for example, a browser extension cooperating with a native messaging host (NMH), a local endpoint agent, an operating-system network monitor, an application plug-in, a software development kit (SDK), or another component configured to observe or receive request context. In some embodiments, a more fully featured endpoint agent may provide additional deployment flexibility or local processing capabilities, such as, but not limited to, intent computation, routing selection, or compatibility with certificate-pinning environments.

In embodiments, the PEP correlates an incoming TLS CONNECT request (e.g., by destination domain extracted from the Server Name Indication (SNI) field or correlating by CONNECT host: port, destination, client identifier, a connection identifier) with a recent authorization beacon and permits or denies establishment of a TLS tunnel based on beacon validity and token verification, without decrypting the tunneled traffic. In embodiments, the NMH monitors non-browser traffic for ZTNA validation.

In some deployments, visibility into Server Name Indication (SNI) may be reduced or unavailable (e.g., due to Encrypted ClientHello (ECH), client configuration, or protocol evolution). Accordingly, correlation between an authorization beacon and a subsequent tunneled connection need not rely solely on SNI, and may instead or additionally be performed using other connection anchors, including a destination identifier from an HTTP CONNECT request (e.g., host: port), a destination network address (e.g., IP address), and/or a verifier-issued connection identifier (e.g., a nonce, token, or handle) provided to the client (directly or via the NMH) and echoed in connection establishment metadata or in the authorization beacon for matching at the PEP.

In some embodiments, authorization is stateless in the sense that the verifier need not maintain a conventional per-client application session or long-lived bearer session, while still permitting use of limited contextual state, such as, but not limited to, replay-protection data, policy-state data, factor-state data, short-lived caches, or time-window validation data.

In some embodiments, a Zero Trust Network Access (ZTNA) broker aggregates user and device trust factors from one or more factor sources (e.g., identity provider, mobile device management, endpoint protection) and provides hashed factor state to the NMH and/or PEP. The ephemeral HMAC token can be bound to such hashed factor state, thereby linking authorization to continuously evaluated posture while avoiding disclosure of raw factor values.

The foregoing and other embodiments may reduce replay risk, avoid reliance on long-lived bearer tokens, and provide scalable enforcement for encrypted communications without TLS termination.

The features and advantages described herein are not all-inclusive and, in particular, many additional features and advantages will be apparent to one of ordinary skill in the art in view of the drawings, specification, and claims.

### BRIEF DESCRIPTION OF THE DRAWINGS

FIG. 1 is a block diagram illustrating an example Zero Trust enforcement system including client-side listening agent, a broker, one or more factor sources, and one or more policy enforcement points, in accordance with embodiments of the present disclosure.

FIG. 2 is a sequence diagram illustrating an example of side-channel authorization for a protected connection or request, including transmission of an authorization beacon and permit/deny determination by a PEP, in accordance with embodiments of the present disclosure.

FIG. 3 illustrates an example token generation process based on an ephemeral key derived from a shared secret and an HMAC computed over hashed factor state and one or more context values, in accordance with embodiments of the present disclosure.

FIG. 4 illustrates an example deterministic seed and nonce evolution process that provides forward-secret key evolution without asymmetric cryptography, in accordance with embodiments of the present disclosure.

FIG. 5 illustrates an example broker process for aggregating trust factors, hashing factor values, and distributing hashed factor state for distributed token generation and validation, in accordance with embodiments of the present disclosure.

FIG. 6 is a flowchart illustrating an example decision process executed by a PEP when receiving a protected request or connection and validating a corresponding authorization beacon, in accordance with embodiments of the present disclosure.

FIG. 7 illustrates an example intent, context, and policy-relevant payload flow for PEP decisioning and optional downstream analytics, in accordance with embodiments of the present disclosure.

FIG. 8 is a flowchart illustrating an example continuous validation method including per-request or repeated validation and invalidation based on policy, factor-state, replay, or timing conditions, in accordance with embodiments of the present disclosure.

### DETAILED DESCRIPTION

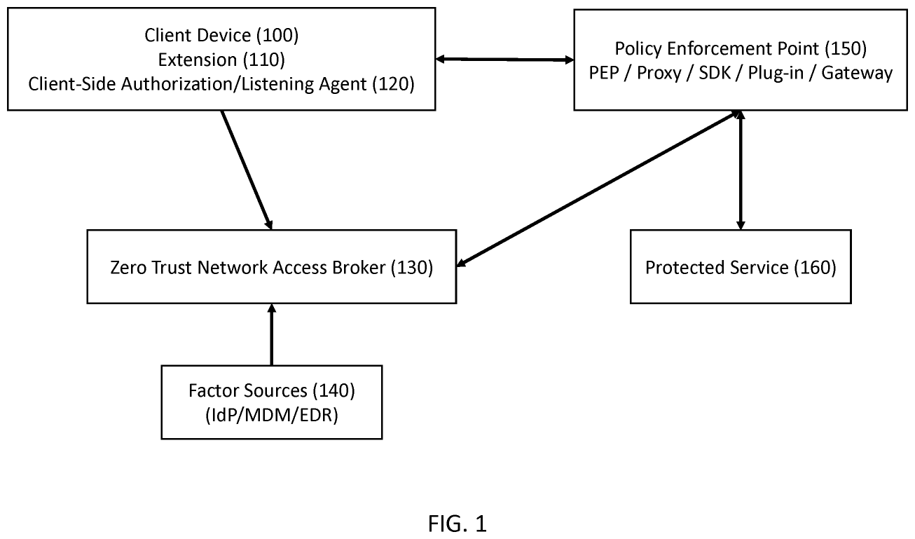

Referring to FIG. 1, embodiments described herein provide a distributed, Zero Trust enforcement architecture that couples stateless, ephemeral authentication tokens with side-channel authorization for encrypted connections. The architecture may include a client device 100 executing one or more client-side listening components, such as, but not limited to, a browser 102 with an extension 110 and a native messaging host (NMH) 120 in one embodiment. In other embodiments, the client-side listening component may comprise a local agent, operating-system component, application plug-in, SDK, or other module configured to observe or receive request context and to generate authorization data. The client device 100 communicates with a policy enforcement point (PEP) 150, which in various embodiments may act as a forward proxy, reverse proxy, gateway, sidecar, service module, application-integrated enforcement component, or other policy enforcement element for protected services 160, such as, but not limited to, SaaS applications and APIs. A ZTNA broker 130 and one or more factor sources 140 may provide trust posture evaluation and cryptographic material used to bind authorization to user and device state.

### Ephemeral Hmac-Based Stateless Authentication

As used herein, ‘stateless’ means that a verifier need not maintain a conventional, long-lived, per-client application session record or server-issued bearer session for access decisions. In some embodiments, however, the verifier, broker, and/or enforcement point may nevertheless maintain or access cryptographic material and limited contextual state, such as, but not limited to, time-window validation data, replay-protection data, short-lived cache entries, factor-state data, policy-state data, or similar information, while the authorization token itself remains independently verifiable from shared cryptographic material and message context. Accordingly, certain embodiments may be characterized as stateless authentication and/or authorization that can leverage stateful context.

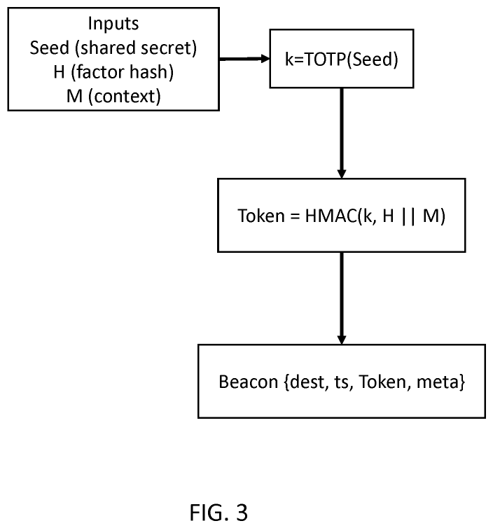

Referring to FIG. 3, in some embodiments the client derives an ephemeral key k from a shared secret Seed (e.g., k=TOTP(Seed)) and generates an ephemeral token Token as a hash-based message authentication code, such as, but not limited to, Token=HMAC(k, H∥M), where H may comprise hashed factor state and M may comprise request context; the token and associated metadata may be included in a request or in a beacon (e.g., {dest, ts, Token, meta}).

In some embodiments, H and/or M may include one or more policy-relevant context values, such as, but not limited to, a destination identifier, timestamp, request nonce, session identifier, connection identifier, bearer token, session cookie, UUID, client identifier, intent value, device posture indicator, or combinations thereof. Hashed factor state is one example of context that may be incorporated, but other context values may additionally or alternatively be bound into the HMAC. For example, a bearer token, session cookie, or other credential artifact may be included in, or used to derive, the message value authenticated by the HMAC, thereby strengthening replay resistance and enabling a proof-of-possession paradigm for otherwise bearer-style credentials.

In some embodiments, a client and a verifier share (directly or indirectly) a root secret Seed. The client derives an ephemeral key, k, that changes over time, for example using a deterministic entropy generator, such as, but not limited to, a time-based one-time password (TOTP) generator: k=TOTP(Seed). The client may compute an authentication token, Token, as a hash-based message authentication code, for example Token=HMAC(k, M), where M includes one or more identifiers or context values. The token may be transmitted with a request, such as, but not limited to, in an HTTP header, a message field of an RPC call, or a metadata field of a beacon message.

In some embodiments, the message value M may include, or may be derived from, a bearer-style credential artifact, such as, but not limited to, an OAuth bearer token, session cookie, session identifier, UUID, nonce, or other request-bound value. For example, an existing bearer token may be used as, or as part of, the message authenticated by the HMAC, such that Token=HMAC(k, M) where M includes the bearer token. In this way, a bearer artifact that would otherwise be replayable on possession alone can be transformed into a proof-of-possession-style artifact bound to ephemeral secret material and, optionally, additional context.

The verifier of embodiments obtains or derives the corresponding Seed for the client (e.g., via provisioning, enrollment, or broker distribution), independently derives the ephemeral key k for the same time step (optionally testing adjacent time steps to accommodate clock skew), recomputes an ExpectedToken =HMAC(k, M), and compares the ExpectedToken to the received Token using a constant-time comparison. The verifier can thereby authenticate and authorize requests without maintaining per-client session state or issuing long-lived bearer tokens.

### Deterministic Forward Secrecy via Seed/Nonce Evolution

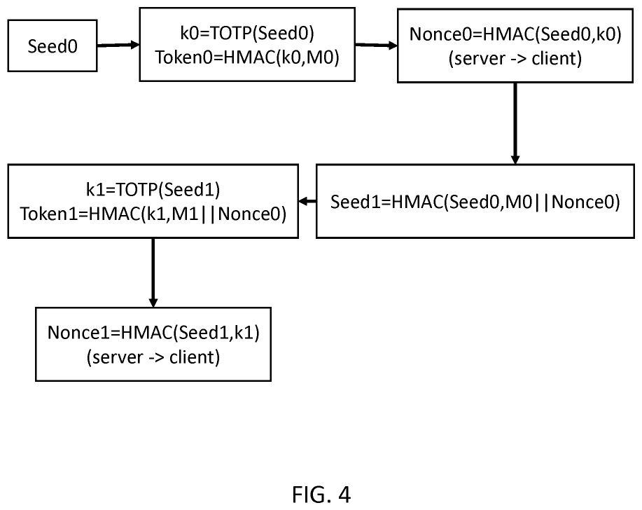

Referring to FIG. 4, deterministic forward-secret evolution may be achieved by deriving nonces from HMAC outputs and updating the seed deterministically (e.g., Seed1=HMAC(Seed0, M0∥Nonce0)) so that compromise of a current seed does not reveal prior or future seeds, while avoiding asymmetric key exchange.

In some embodiments, forward-secret key evolution is achieved using deterministic updates to a shared seed and nonces derived from HMAC outputs. For example, an initial seed Seed0 may be used to derive k0=TOTP(Seed0) and Token0=HMAC(k0, M0). A nonce may be derived as Nonce0=HMAC(Seed0, k0) and returned to the client. Both parties may then update the seed deterministically, for example Seed1=HMAC(Seed0, M0∥Nonce0), derive k1=TOTP(Seed1), and compute Token1=HMAC(k1, M1∥Nonce0). The process may repeat to generate a sequence of seeds and nonces (SeedN, NonceN) such that compromise of one seed does not reveal prior or future seeds, while avoiding asymmetric key exchange.

### Side-Channel Authorization for TLS-Preserving Enforcement

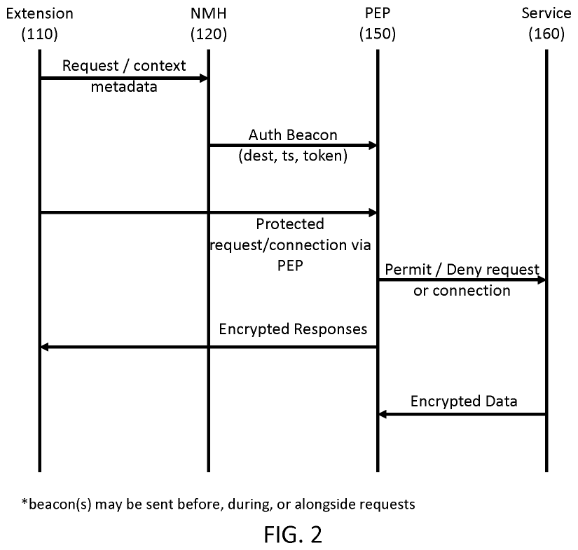

Referring to FIG. 2, the extension 110 may provide request metadata for a protected destination to the NMH 120, the NMH 120 may transmit an authorization beacon (e.g., including dest, ts, and Token) to the PEP 150, and the client may subsequently initiate a protected request, connection, or transport session via or toward the PEP 150. In some embodiments, this comprises a TLS CONNECT request used to establish a TLS tunnel. In other embodiments, the PEP 150 may receive another request, connection, or application-level message associated with the protected destination. In embodiments, tunneled data remain encrypted, such as, but not limited to, by TLS, end-to-end.

In some embodiments, the authorization beacon is transmitted prior to initiation of the request or connection, during initiation, or alongside individual requests for per-request validation. Continuous or repeated validation may be used so that the PEP can deny or terminate access if authorization is later revoked, such as, but not limited to, due to policy change, factor-state change, replay detection, or other invalidation condition.

In some embodiments, access to a protected destination is enforced without decrypting TLS traffic by using a side-channel authorization beacon. The extension 110 may observe initiation of a navigation or request to a protected destination (e.g., by domain) and transmit request metadata to the NMH 120. The NMH 120 may determine a PEP 150, which may be a distributed PEP 150, for the destination and send an authorization beacon to the PEP 150. The beacon may include context, such as, but not limited to, a destination identifier, a timestamp, a session identifier, device posture indicators, and an ephemeral token generated as described herein.

In embodiments, the NMH 120 monitors native applications, such as, but not limited to, Secure Shell (SSH), Remote Desktop Protocol (RDP), and others.

When the client subsequently initiates a TLS tunnel to the destination through the PEP 150 (e.g., via an HTTPS CONNECT request), the PEP 150 correlates the incoming connection to a recent beacon. In some embodiments, the PEP 150 extracts a destination domain from the Server Name Indication (SNI) extension in the TLS ClientHello message and uses the destination domain to locate a corresponding beacon. If a valid beacon is found within a configured time window and token verification succeeds, the PEP 150 permits establishment of the TLS tunnel. Otherwise, the PEP 150 denies the connection. The PEP 150 may enforce policy while preserving end-to-end encryption between the client and the protected service 160, improving privacy and performance.

Correlation between the authorization beacon and the subsequent request or connection need not rely solely on SNI and may instead or additionally use one or more correlation anchors, such as, but not limited to, a CONNECT host: port value, destination domain, destination network address, client identifier, connection identifier, verifier-issued nonce, token, handle, or other metadata available to the PEP.

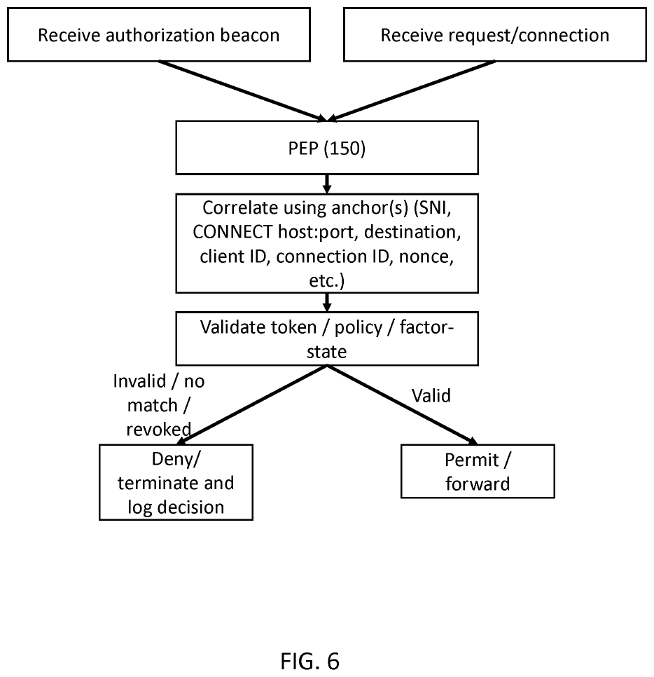

Referring to FIG. 6, the PEP 150 may receive a TLS CONNECT request (e.g., SNI=dest), determine whether a matching authorization beacon is present within a time window, and permit forwarding of the tunnel or deny and log the decision.

In embodiments, the PEP 150 informs a broker, such as, but not limited to, a ZTNA broker 130, of session continuity or invalidation events.

### Zero Trust Extension Architecture With Broker-Distributed Hashed Factor State

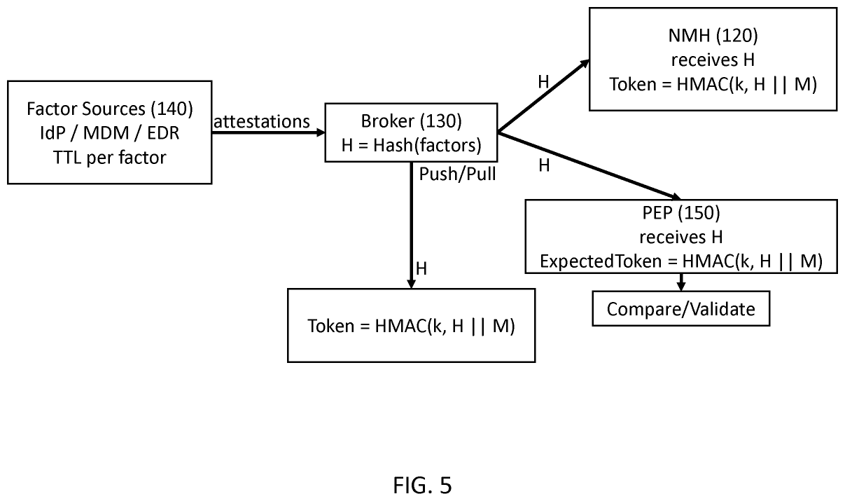

Referring to FIG. 5, factor sources 140 (e.g., IdP, MDM, and EDR) may provide attestations and trust signals to the broker 130, which may apply per-factor TTLs based on volatility, compute a hashed factor state H=Hash(factors), and distribute H to the NMH 120 (e.g., via push or pull) to enable generation and validation of Token=HMAC(k, H∥M).

In some embodiments, a ZTNA broker 130 aggregates trust factors from one or more factor sources 140. Factor sources 140 may include an identity provider (IdP) (identity assertions, group membership), a mobile device management (MDM) system (device health, encryption status), endpoint detection and response (EDR) tools (AV, EDR, XDR posture), the PEP 150, or other posture authorities or local/distributed resources. Such aggregation of factor sources 140 can, inter alia, provide API-based lookups for identity and device context and support TTLs per factor based on volatility.

In embodiments, the broker 130 selects a set of factors relevant to a policy, applies time-to-live (TTL) rules to the factors based on volatility, and computes a hashed factor state H from selected factor values. The broker 130 provides H to the NMH 120 and/or to the PEP 150, for example using push distribution or pull retrieval.

In some embodiments, the NMH 120 computes an ephemeral authorization token that binds authorization to the hashed factor state, for example Token=HMAC(k, H∥M), where k is derived from Seed and M includes context such as, but not limited to, destination domain, timestamp, or session identifier. The PEP 150 independently recomputes the expected token using the same H, Seed, and context M. In this way, authorization can depend on continuously evaluated posture without disclosing raw factor values to the PEP 150 or other intermediaries.

In some embodiments, the broker 130 distributes hashed factor state H to both the client-side listening component 120 and the PEP 150, thereby enabling the client-side listening component 120 to generate Token=HMAC(k, H∥M) and enabling the PEP 150 independently to generate a corresponding expected token using the same H and message context M for comparison.

In embodiments, the ZTNA broker 130 stores long-and short-lived trust signals, shares hashed factor states with PEPs 150 to allow local token validation, and maintains trust-factor state/TTLs for ongoing sessions.

### Routing, Caching, and Continuous Validation

In some embodiments, traffic associated with protected destinations is steered toward an appropriate PEP 150 using one or more routing or traffic-steering mechanisms. Such mechanisms may include, for example, administrator-deployed proxy settings, proxy auto-config (PAC) files, local routing rules, DNS-based selection, application configuration, endpoint policy, or other known traffic-steering methodologies. In some embodiments, a client-side component may select among available PEPs based on destination, policy, or network locality.

In some embodiments, the NMH 120 dynamically generates and installs a proxy auto-config (PAC) file or other routing configuration so that requests to protected destinations are directed through an appropriate PEP 150, while other traffic is routed normally. The PEP 150 may maintain a short-lived cache, mapping destinations and/or connection identifiers to recent beacons to enable high-speed validation. Validation may be performed per request, per connection, or per time slice, thereby supporting continuous enforcement, consistent with Zero Trust principles, that is also silent and transparent to the end user. Authorization may be validated per request, per connection, per message, or at selected intervals. Invalidation may occur upon policy change, factor-state change, replay or injection detection, detection of risk signals, or, in some embodiments, expiration of a time-to-live associated with one or more factors or tokens. In this respect, the techniques described herein differ from SPA-style approaches that provide a time-based admission decision at the network layer, supporting repeated or per-request validation tied to application-relevant context.

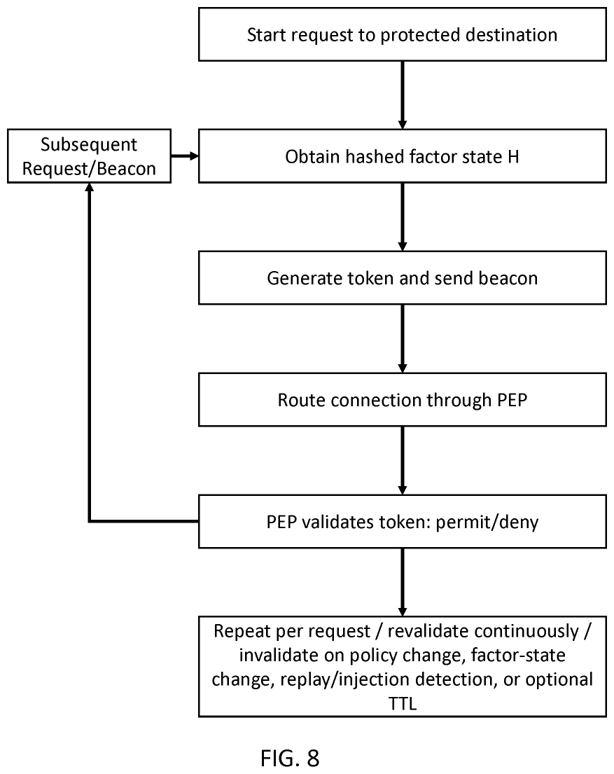

Referring to FIG. 8, the foregoing operations may be repeated for multiple requests, including obtaining hashed factor state H, generating a token and sending an authorization beacon, routing a connection through the PEP 150, and validating the token to permit or deny access, wherein authorization may be re-evaluated or invalidated based on one or more of factor-state change, policy change, replay or injection detection, risk signals, or optional timing-based expiration.

### Intent, Context, and Optional Analytics Without Payload Decryption

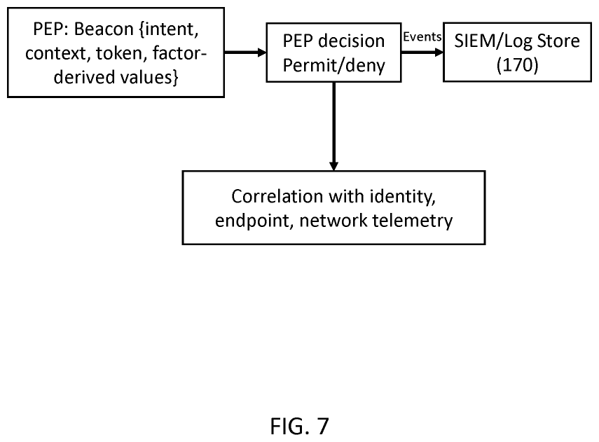

Referring to FIG. 7, the client-side listening component may provide an authorization beacon or related payload that includes intent data, context data, factor-derived values, or other policy-relevant information to the PEP 150. The PEP 150 may use such information, together with token validation, to make a permit/deny determination. In some embodiments, some or all of such information may additionally be forwarded to analytics or logging systems for downstream correlation, such as, but not limited to, with identity, endpoint, and network telemetry.

In some embodiments, the extension 110, NMH 120, broker 130, and/or PEP 150 generate log events representing intent, context, and enforcement outcomes. These events may be forwarded to a security information and event management (SIEM) system 170 for correlation with identity, endpoint, and network telemetry. Because, in such embodiments, policy decisions are made based on metadata and cryptographic proof, rather than decrypted payload inspection, analytics and forensics may be performed without compromising the confidentiality of TLS-protected data and without requiring significant processing power to be expended (e.g. to decrypt/encrypt).

### Example Use Cases and Notable Variations

Embodiments may be used for browser-based access to SaaS services, API clients, IoT devices, service-to-service communications, remote administration protocols (e.g., SSH or RDP), and other environments in which sessionless authentication and TLS-preserving enforcement are desired. Variations may include different entropy sources for ephemeral key rotation, different message constructions for M, deployment of multiple PEPs with selection based on network locality, and alternative correlation strategies between beacons and connections. In some embodiments, the same token mechanism is used both for request-level API authentication and for side-channel beacons that authorize TLS tunnel establishment.

In some embodiments, the same token-generation mechanism may be used both for request-level authentication and for side-channel authorization beacons. In some embodiments, message constructions may bind the token to a bearer token, session cookie, UUID, nonce, intent value, or other context, thereby strengthening authentication and authorization without transmitting the underlying secret.

The foregoing description of the embodiments of the invention has been presented for the purposes of illustration and description. It is not intended to be exhaustive or to limit the invention to the precise form disclosed. Many modifications and variations are possible in light of this disclosure. For instance, the various operations, functions, blocks, modules, and components described herein may be implemented in hardware, software, firmware, or any combination thereof, and may be embodied as instructions stored on one or more non-transitory computer-readable media and executed by one or more processors. Further, the functions attributed to a given device, module, or component (e.g., an extension, native host, broker, enforcement point, proxy, or service) are provided for purposes of illustration and may be combined with one another, subdivided, or redistributed across multiple devices or computing systems. Such devices or computing systems may be co-located or geographically distributed, may communicate over wired and/or wireless links (including through one or more networks), and may operate in a client-server, peer-to-peer, distributed, cloud, virtualized, containerized, or microservices environment. Additionally, unless expressly stated otherwise, steps and operations described in connection with the methods herein need not occur in the particular order shown, may be performed in parallel or iteratively, and may be omitted, repeated, or supplemented, while still achieving the described functionality. The specific embodiments described are exemplary and do not limit the scope of the claims.

It is intended that the scope of the invention be limited not by this detailed description, but rather by the claims appended hereto.

What is claimed is:

1. A system comprising:
a client device including a client-side listening agent configured to detect or receive information associated with a request to a protected destination; and
a policy enforcement point (PEP) configured to receive, intercept, or evaluate a request, connection, or communication associated with the protected destination,
wherein the client-side listening agent is configured to generate an authorization beacon comprising an ephemeral token computed as a hash-based message authentication code (HMAC) over a message that includes at least a destination identifier and to transmit the authorization beacon to the PEP,
and
wherein the PEP is configured to permit or deny access to the protected destination based at least on validation of the authorization beacon.

2. The system of claim 1, wherein the ephemeral token is computed using an ephemeral key derived from a shared secret by a deterministic key-derivation mechanism.

3. The system of claim 2, wherein the deterministic key-derivation mechanism comprises a time-based one-time password (TOTP) generator.

4. The system of claim 1, further comprising a Zero Trust Network Access (ZTNA) broker configured to compute a hashed factor state from one or more trust factors obtained from one or more factor sources, and to distribute the hashed factor state to at least one of a native messaging host (NMH) of the client-side listening agent or the PEP.

5. The system of claim 4, wherein the ephemeral token is computed as HMAC(k, H∥M), where k is derived from the shared secret, H comprises the hashed factor state, and M comprises message context.

6. The system of claim 4, wherein the broker assigns time-to-live values to trust factors based on volatility and invalidates authorization when a time-to-live expires.

7. The system of claim 1, wherein the PEP correlates the TLS tunnel request to the authorization beacon using a destination domain extracted from a Server Name Indication (SNI) field in a TLS ClientHello message.

8. The system of claim 1, wherein traffic associated with the protected destination is steered toward the PEP using one or more routing mechanisms.

9. The system of claim 1, wherein the NMH monitors outbound connections from a non-browser application and generates corresponding authorization beacons for the non-browser application.

10. The system of claim 1, wherein the authorization beacon includes at least one of a timestamp, a session identifier, a device posture indicator, or an intent indicator.

11. The system of claim 1, wherein the PEP denies the TLS tunnel request if no matching authorization beacon is found within a predetermined time window.

12. The system of claim 1, wherein at least one of the NMH or the PEP generates log events representing the request intent and an enforcement decision and forwards the log events to a security analytics platform.

13. The system of claim 1, wherein the authorization beacon is transmitted prior to initiation of the TLS tunnel request or during initiation of the TLS tunnel request.

14. A method comprising:
detecting, by a client-side listening agent or agent component, initiation of a network request to a protected destination;
generating, by the client-side listening agent, an ephemeral token using a hash-based message authentication code (HMAC) with an ephemeral key;
transmitting, by the client-side listening agent, an authorization beacon including the ephemeral token to a policy enforcement point (PEP);
receiving, by the PEP, a request associated with the protected destination;
correlating the request to the authorization beacon;
validating, by the PEP, the authorization beacon; and
permitting or denying the request based on the validation.

15. The method of claim 14, wherein correlating the request comprises extracting a destination domain from a Server Name Indication (SNI) field of a TLS ClientHello message.

16. The method of claim 14, wherein generating the ephemeral token comprises deriving the ephemeral key using a time-based one-time password generator based on a shared secret.

17. The method of claim 16, further comprising evolving a shared seed using a deterministic HMAC-based nonce evolution process.

18. The method of claim 14, further comprising dynamically configuring proxy routing for the protected destination using one or more routing mechanisms.

19. The method of claim 14, further comprising obtaining a hashed factor state from a Zero Trust Network Access (ZTNA) broker and binding the ephemeral token to the hashed factor state.

20. A computer-implemented method for providing stateless authentication and authorization of a client with respect to a protected resource, the method comprising:
receiving, by a server computing system, a request to access the protected resource, the request including (i) a token and (ii) request data;
determining, by the server computing system, a time value associated with the request and selecting a time window for validating the token;
deriving, by the server computing system, an ephemeral secret key as a deterministic function of at least (i) a shared secret associated with the client and (ii) the time value;
computing, by the server computing system, an expected token by applying a keyed cryptographic function to (i) the ephemeral secret key and (ii) a message value derived from the request data, wherein the message value binds the token to at least one of: a resource identifier, a destination identifier, a client identifier, a request nonce, a bearer token, a session cookie, a UUID, an intent value, or a hashed representation of one or more authentication or device-posture factors;
validating the token by comparing the token to the expected token for at least the selected time window; and
in response to validating the token, authorizing the request to access the protected resource, and otherwise denying the request,
wherein the server computing system authorizes the request without maintaining a conventional long-lived per-request session state for the client beyond information used to compute the expected token for the selected time window.
